(19) United States
(12) Patent Application Publication
(10) Pub. No.: US 2002/0143812 A1
(43) Pub. Date: Oct. 3, 2002

(54) System and method of automatically updating content on a web site

(76) Inventor: James C. Bedingfield, Lilburn, GA (US)

Correspondence Address: David L. Marcus, WOODCOCK WASHBURN KURTZ, MACKIEWICZ & NORRIS LLP, One Liberty Place - 46th Floor, Philadelphia, PA, 19103, US

(21) Appl. No.: 09/817,944

(22) Filed: Mar. 27, 2001

(51) Int. Cl. G06F 15/00

(52) U.S. Cl. 707/511; 707/513

(57) ABSTRACT

A method of automatically updating content on a web site. The method comprises accessing an update profile containing a named party, a named party URL, and an update frequency, determining whether web site content is due to be updated based on the update frequency, retrieving a copy of the web site content based on the named party URL, presenting the copy to the named party, receiving a revised copy from the named party, and updating the web site content based on the revised copy received from the named party. The update profile may further comprise a named party e-mail address, the copy of the web site content may be presented to the named party as an e-mail attachment, and the revised copy of the web site content may be received from the named party as an email attachment.

### BACKGROUND

A. Field of the Invention

This invention relates generally to the field of web site administration, and particularly to systems and methods for automatically updating content on a web site.

B. Description of the Related Art

Web sites today often have numerous pages and contain large amounts of content in the form of graphics, text, links, banner advertising, and the like. Maintaining this content current and up-to-date can therefore become quite demanding. The process of manually accessing and evaluating the content on each page can be both tedious and time-consuming, and therefore easily put aside by web site owners/administrators who are pressed for time and resources. Nonetheless, for many web site owners/administrators (such as a small business owners) maintaining the content on one's web site current can be quite important. Therefore, a method that would automatically access one's web site and present content to the web site owners/administrators for periodic review would encourage the web site owners/administrators to maintain their web sites current while easing the burden of doing so at the same time.

### II. SUMMARY OF THE INVENTION

A method of updating content on a web site, the method comprising: accessing an update profile, the update profile comprising a named party URL, and an update frequency; determining whether web site content is due to be updated based on the update frequency; retrieving a copy of the web site content based on the named party url; presenting the copy to a named party; receiving a revised copy from the named party; and updating the web site content based on the revised copy received from the named party. In one embodiment of the invention, the update profile may further comprise a named party e-mail address, the presenting step may comprise mailing the copy of the web site content to the named party as an e-mail attachment, and the receiving step may comprise receiving from the named party a reply e-mail with a revised copy of the web site content attached to the reply e-mail as an attachment.

A computer running executable code, the executable code programmed to: access an update profile, the update profile comprising a named party, a named party URL, and an update frequency; determine whether content on a web site is due to be updated based on the update frequency; retrieve a copy of the web site content based on the named party URL; present the copy to the named party; receive a revised copy from the named party; and update the web site content based on the revised copy received from the named party. The update profile may further comprise a named party e-mail address, the copy of the web site content may be presented to the named party as an e-mail attachment, and the revised copy of the web site content may be received from the named party as an e-mail attachment. The update profile may comprise a web page on the web site.

A system for automatically updating content on a named party's website, comprising: a server having non-volitile memory; updating software resident on the server; e-mail software resident on the server; a web hosting server having a named party URL and content resident thereon; means for communicating between the server and the named party; and means for communicating between the server and the web hosting server. An update profile may reside in the non-volitile memory, and may comprise a page of the content. The update profile may also comprise a named party url field, a named party e-mail address field, and an update frequency field.

### III. BRIEF DESCRIPTION OF THE DRAWINGS

These and other features, aspects, and advantages of the present embodiment of the invention will become better understood with regard to the following description, appended claims, and accompanying drawings where:

FIG. 1 is a block diagram depicting a computer running executable code in one embodiment of the invention; and

FIG. 2 is a flow chart depicting the steps performed in one embodiment of the invention.

### IV. DETAILED DESCRIPTION OF THE PREFERRED EMBODIMENTS

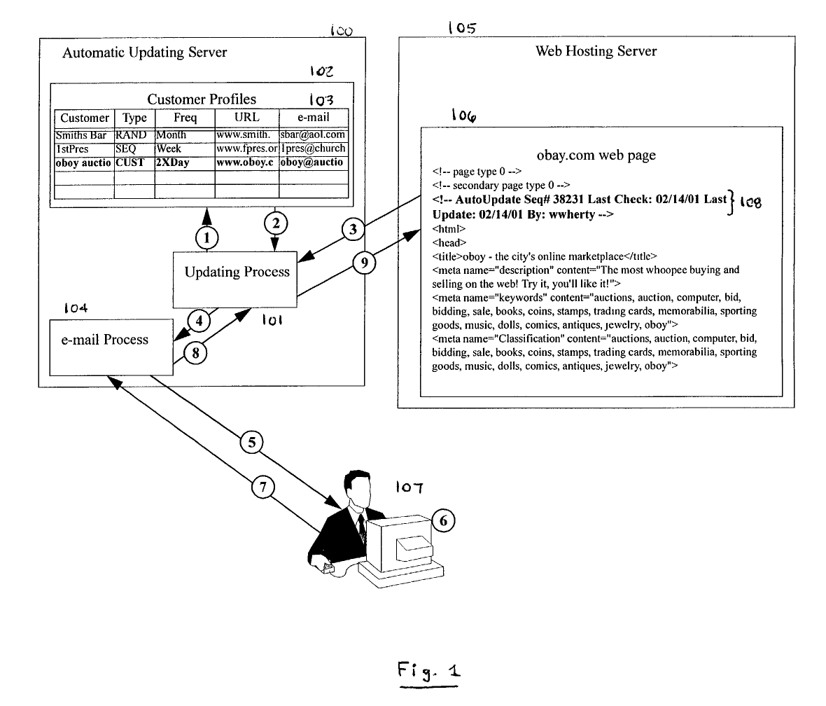

Throughout the following detailed description similar reference numbers refer to similar elements in all the FIGS. of the drawings. FIG. 1 is a block diagram depicting a computer 100 running executable code or software 101, 104 in one embodiment of the invention. Computer 100 is a typical server with non-volitile memory 102. Residing in memory 102 are a plurality of programmable update profiles or customer profiles 103. Each customer who wishes to have content 106 on his or her web site automatically updated by server 100 has their own profile or row in the table of customer profiles 103. The fields comprising each update profile are a named party or customer, an update type, an update frequency, a named party uniform resource locator or URL, a named party e-mail address, and the like. The named party field identifies the owner or administrator of a web site. The named party URL identifies the address of the named party's web hosting server 105 on the public or a private internet. The update frequency identifies how often the named party wants updating process 101 to access the named party's web site and select content to be updated. Typical frequencies might be twice daily, daily, weekly, monthly, or the like.

The update type identifies how the named party wants updating process 101 to select content to be updated after updating process 101 accesses the named party's web site. Typical update types might be random (RAND), sequential (SEQ), custom (CUST), and the like. If a named party specifies a random update type, updating process 101 accesses the named party's web site using the named party's URL and randomly selects content from at least one web page 106 on the named party's web hosting server 105. If a named party specifies a sequential update type, updating process 101 accesses the named party's web site using the named party's URL and sequentially selects content from at least one web page 106 on the named party's web hosting server 105. Updating process could sequentially select content from a single web page 106 or sequentially step through multiple pages selecting content from each page 106 when accessed. If a named party specifies a custom update type, updating process 101 accesses the named party's web site using the named party's URL and selects content from at least one web page 106 in a manner specifically set out by the named party when creating or revising his or her update profile. For instance, the named party could specify that content from only certain pages such as the homepage or frequently accessed pages be selected for updating. The named party may also specify that only certain graphics and/or text be selected for updating. Any number of combinations are possible.

Once updating process 101 determines that it is time to access a named party's web site 105 and selects the appropriate content, updating process 101 passes a copy of the selected content and the named party's e-mail address to e-mail process 104. E-mail process 104 creates an e-mail message to the named party informing him or her that it is time to update content on his or her web site, and appends a copy of the selected content to the e-mail message as an attachment or attachments. When the named party 107 receives the e-mail message from e-mail process 104 he or she opens the message and decides whether to update the attached content. If the named party decides to update the content he or she does so by revising the copy of the selected content in the attachment, which includes replacing the attachment with new content, and sending a reply message back to e-mail process 104. If the named party decides not to update the content he or she simply sends a reply message to e-mail process 104 with no changes to the attachment. If the named party does not reply to the e-mail from e-mail process 104, in one embodiment of the invention updating process 101 will ignore the lack of response and continue to generate e-mail messages to the named party in accordance with the named party's update profile 103. In another embodiment of the invention, if the named party fails to reply to the e-mail message from e-mail process 104 updating process 101 will send reminder e-mails to the named party until he or she responds. Whether updating process 101 ignores a lack or response or sends reminder e-mails, and the frequency and/or number of reminder e-mails, may be an option specified in the named party's update profile 103.

Upon receipt of a reply message from named party 107 e-mail process 104 passes the attachment containing the revised copy of the selected content to updating process 101. Upon receipt of the attachment from e-mail process 104 updating process 101 updates the named party's web site 105 and an update log 108 (contained in the remarks section of at least one web page 106 for example) based on the changes to the revised copy of the selected content, if any. Update log 108 contains information such as an automatic update sequence number (AutoUpdate Seq #) field, a last checked date field, a last updated date field, a last updated by field, and the like. E-mail process 104 may constitute any of a number of e-mail packages such as MICROSOFT OUTLOOK, EUDORA, or the like. If e-mail process 104 supports rich text formatting of e-mail messages then updating process 101 can update the formatting of textual content on the named party's web site by mapping the rich text format to hypertext markup language or HTML.

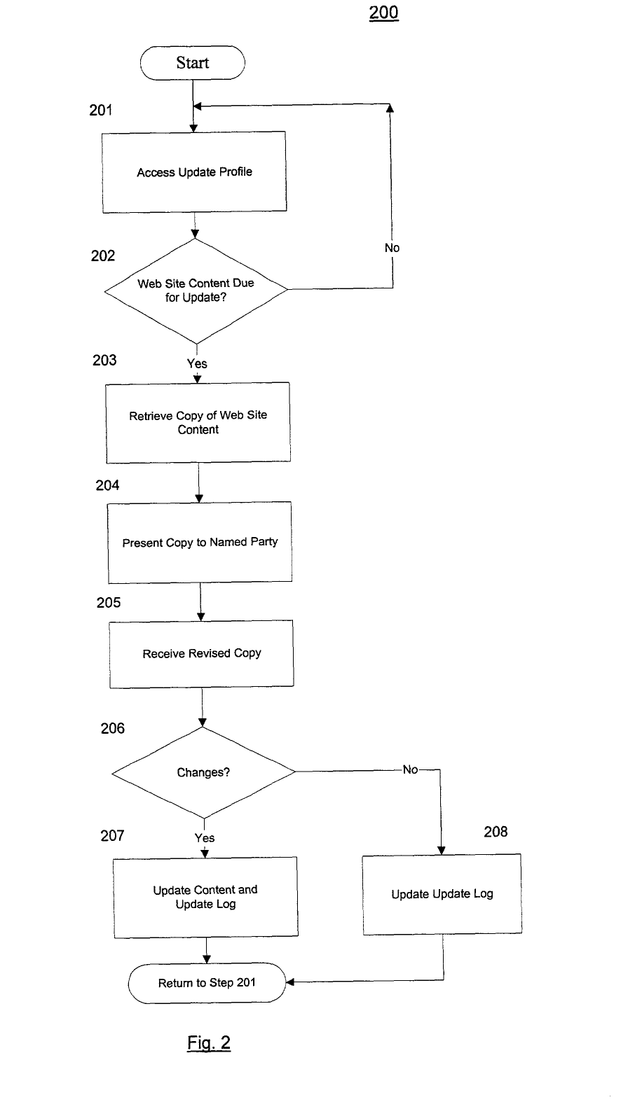

FIG. 2 is a flow chart depicting the steps in process 200, another embodiment of the invention. In step 201 the process accesses a named party's update profile. In step 202 the process determines whether any content on the named party's web site is due for an update. If no content is due to be updated the process returns to step 201. If content is due to be updated, in step 203 the process 101 retrieves a copy of the web site content to be updated based on the named party's URL. In another embodiment of the invention, the process may retrieve a copy of the web site content to be updated based on the named party's URL and a specified update type. In step 204, the process presents the copy of the web site content to the named party for review. In step 205, the process receives a revised copy of the content from the named party. In another embodiment of the invention, the copy of the web site content is presented to the named party as an attachment to an e-mail message sent to the named party by the process, and the revised copy of the web site content is received from the named party as an attachment to a reply e-mail sent to the process by the named party. In step 206 the process determines whether the revised copy of the content contains any changes to the content on the named party's web site. If there are changes to the content, in step 207 the process updates the content on the named party's web site to reflect the changes. In step 207 the process also updates an update log to reflect changes in an automatic update sequence number, a last checked date field, a last updated date field, a last updated by field, and the like. If no changes to the content are detected in step 206, in step 208 the process updates the update log to reflect changes in only the automatic update sequence number and the last checked date field.

While the invention has been described in connection with the embodiments depicted in the various figures, it is to be understood that other similar embodiments may be used or modifications and additions may be made to the described embodiments for performing the same function of the invention without deviating therefrom. For example, automatic updating server 100 could be part of web hosting server 105, e-mail process 104 could reside on a server separate from automatic updating server 100, and customer profiles 103 need not reside in memory 102 but could comprise a web page on each named party's web server 105. Moreover, updating process 101 could be built as a client that runs each time a named party boots up his or her personal computer, examines the named party's web site via a resident web browser, and provides pop-up or on-screen reminders when content is due to be updated. Therefore, the invention should not be limited to any single embodiment, but rather construed in breadth and scope in accordance with the appended claims.

I claim:

1. A method of updating content on a web site, the method comprising:
accessing an update profile, the update profile comprising a named party URL, and an update frequency;
determining whether web site content is due to be updated based on the update frequency;
retrieving a copy of the web site content based on the named party url;
presenting the copy to a named party;
receiving a revised copy from the named party; and
updating the web site content based on the revised copy received from the named party.

2. The method of claim 1, wherein the update profile further comprises a named party e-mail address, the presenting step comprises mailing the copy of the web site content to the named party as an e-mail attachment, and the receiving step comprises receiving from the named party a reply e-mail with a revised copy of the web site content attached to the reply e-mail as an attachment.

3. The method of claim 1, wherein the web site content contains an update log and the updating step further comprises updating the update log.

4. The method of claim 3, wherein the update log comprises a last checked field and a last updated field.

5. The method of claim 1, wherein the update profile further comprises an update type and the retrieving step comprises retrieving a copy of the web site content based on the named party URL and the update type.

6. The method of claim 1, wherein the update profile comprises a web page on the web site.

7. A computer running executable code, the executable code programmed to:
access an update profile, the update profile comprising a named party, a named party URL, and an update frequency;
determine whether content on a web site is due to be updated based on the update frequency;
retrieve a copy of the web site content based on the named party URL;
present the copy to the named party;
receive a revised copy from the named party; and
update the web site content based on the revised copy received from the named party.

8. The computer of claim 7, wherein the update profile further comprises a named party e-mail address, the copy of the web site content is presented to the named party as an e-mail attachment, and the revised copy of the web site content is received from the named party as an e-mail attachment.

9. The computer of claim 7, wherein the update profile further comprises an update type and the executable code is further programmed to retrieve the copy of the web site content based on the update type.

10. The computer of claim 7, wherein the update profile comprises a web page on the web site.

11. A system for automatically updating content on a named party's website, comprising:
a server having non-volitile memory;
updating software resident on the server;
e-mail software resident on the server;
a web hosting server having a named party URL and content resident thereon,
means for communicating between the server and the named party; and
means for communicating between the server and the web hosting server.

12. The system of claim 11, wherein an update profile resides in the non-volitile memory.

13. The system of claim 11, wherein an update profile comprise a page of the content.

14. The system of claim 12 or 13, wherein the update profile comprises a named party url field, a named party e-mail address field, and an update frequency field.

15. The system of claim 14, wherein the update profile further comprises an update type field.

16. The system of claim 11, wherein the content contains an update log.

17. The system of claim 16, wherein the update log comprises a last checked field and a last updated field.
